(19) United States
(12) Patent Application Publication
(10) Pub. No.: US 2012/0050006 A1
(43) Pub. Date: Mar. 1, 2012

(54) Dynamically Configured User Interface for Access Control Systems

(75) Inventor: Ron DeBlaey, New Berlin, WI (US)

(73) Assignee: Honeywell International Inc., Morristown, NJ (US)

(21) Appl. No.: 12/862,357

(22) Filed: Aug. 24, 2010

(51) Int. Cl. G08B 29/00; G06F 15/00; G06F 17/30

(52) U.S. Cl. 340/5.7; 707/722; 702/188; 707/E17.044

(57) ABSTRACT

A system and method provide real-time configuration information as to a plurality of doors which are part of an access control system. Configuration information can be obtained for each one of a plurality of door of the system. That information can be forwarded to a requestor to provide a real-time representation of the status of the doors of the system and to enable the requestor to configure selected doors.

### FIELD

The invention pertains to access control systems. More particularly, the invention pertains to such systems which can determine the number and status of doors in the system and create real-time user displays indicative of those doors and their respective status.

### BACKGROUND

An access control system can consist of a number of doors and associated hardware and a control system. User interfaces can be of assistance in the set up and operation of such systems. DeBlaey et al. U.S. patent application No. 2009/0282366 published Nov. 12, 2009 and entitled, “Heuristic and Intuitive User Interface for Access Control Systems” which is assigned to the assignee hereof and incorporated herein by reference discloses one such interface.

The number of doors is an important factor when constructing the configuration pages in a user interface for access control systems because it affects many of the pages the user must interact with. For example, the number of doors must be known when rendering the following pages in the user interface:

Door configuration—only doors that exist in the system are allowed to be configured; access levels—only doors that exist in the system may be selected to be in an access level; input configuration—only inputs associated with doors that are in the system are allowed to be assigned to a door; outputs configuration—only outputs associated with doors that are in the system are allowed to be assigned to a door; reader configuration—only readers associated with doors in the system are allowed to be configured; only outputs associated with doors that are in the system may be assigned as the reader's duress output; and, landing page, only doors that are in the system are allowed to be selected by the user for configuration.

In addition, ‘internal housekeeping’ mechanisms (such as the building and refreshing of data caches required to maximize performance) must know the number of doors that actually exist in the system in order to properly manage it. Since the access control system may be configured to run in one of several different configurations (one each for as many doors as are in the system), the user interface that displays current system status must allow for any of these configurations. Consequently, a mechanism is required to automatically determine which configuration the system is currently running in. Once the configuration is determined, the proper technique for displaying it is then chosen in order to convey the correct information to the user.

Several user interface techniques exist to convey the correct configuration to the user; these include one or some combination of: disabling of controls associated with the non-existent doors. The controls are visible but are unresponsive to the user. However this can lead to confusion on the user's part as to why their interaction to the system is being ignored. Alternately, the non-existent doors can be configured by the user and an auxiliary notification mechanism can be provided. For example, posting pop up messages to inform the user that the configuration is invalid because the door being configured isn't online. This can lead to annoyance on the part of the user when informed that they've made an invalid choice. Some combination of the above can be used.

In yet another approach, the user is allowed to make the same configuration choices regardless of the current configuration of the system. No errors or notifications are given and user is not prompted with any information about the current configuration of the system. This can also lead to user confusion and annoyance. Finally, the system can be displayed exactly as it actually exists in real time. Controls for non-existent doors are not visible and all I/O associated with non-existent doors are eliminated from any I/O selection. The user is therefore always given the correct picture of the system. This avoids inappropriate user interaction and creates minimal user confusion.

### BRIEF DESCRIPTION OF THE DRAWINGS

FIG. 1 is a block diagram of a system which embodies the invention;

FIG. 2A is an exemplary user display of a system having a single door;

FIG. 2B is an exemplary user display of a multi-door access control system in accordance with the invention; and

FIG. 3 is a flow diagram illustrating aspects of a process which embodies the invention.

### DETAILED DESCRIPTION

While embodiments of this invention can take many different forms, specific embodiments thereof are shown in the drawings and will be described herein in detail with the understanding that the present disclosure is to be considered as an exemplification of the principles of the invention, as well as the best mode of practicing same, and is not intended to limit the invention to the specific embodiment illustrated.

In one aspect of the invention, the system of interest is queried to determine the number of active doors in the system. Web pages and the elements contained within them are built dynamically so they always display the system as it actually exists. That is, the user isn't required to remember or determine the system's configuration in order to make the correct configuration choices for proper operation.

Automatic discovery of major elements of the access control system's configuration also conveys an impression of greater cost effectiveness to the user. In this regard, the system may well be perceived as “smart enough” to determine important configuration factors automatically. This minimizes system training time, setup time and maximizes user satisfaction.

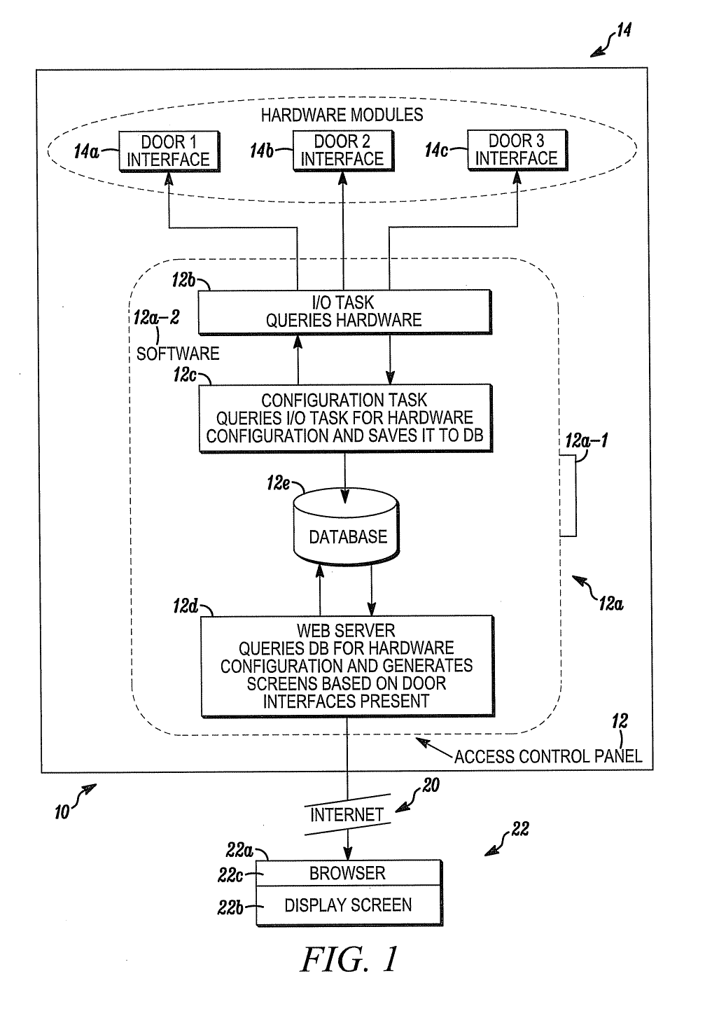

FIG. 1 illustrates a system 10 in accordance with the present invention. System 10 includes an access control panel 12 which is coupled, wired or wirelessly, with a plurality of door interface modules 14.

The members of the plurality 14, as will be understood by those of skill in the art, include door control circuits, hardware and software to lock and unlock respective doors. The number of doors, and associated interfaces, such as 14i, are not limitations of the invention.

The access control panel 12 can include control circuits 12a, including a programmable processor 12a-1, and executable control software 12a-2 including at least one I/O Task 12b, executable by processor 12a, which communicates with the plurality of door interfaces 14a, 14b . . . 14n. A Configuration Task 12c is also executed by processor 12a-1 which obtains door interface information via the I/O Task 12b. A Web Server 12d provides communications with a user as explained below. The control circuitry 12a can also include a magnetic or solid state storage unit for a database 12e wherein door related information can be stored for use by, for example, the Web Server 12d.

The access control panel 12 can communicate via server 12d and a computer network 20, such as the Internet, with a displaced operator unit 22. Unit 22 could be implemented with a personal computer 22a, a display unit 22b and communications software such as an Internet Browser 22c.

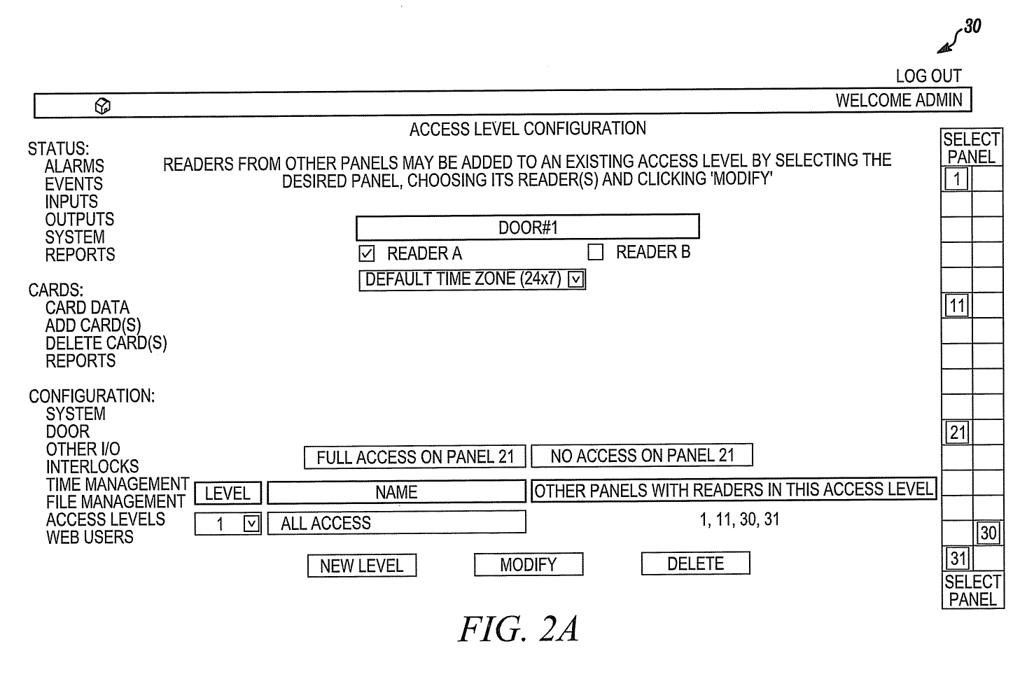

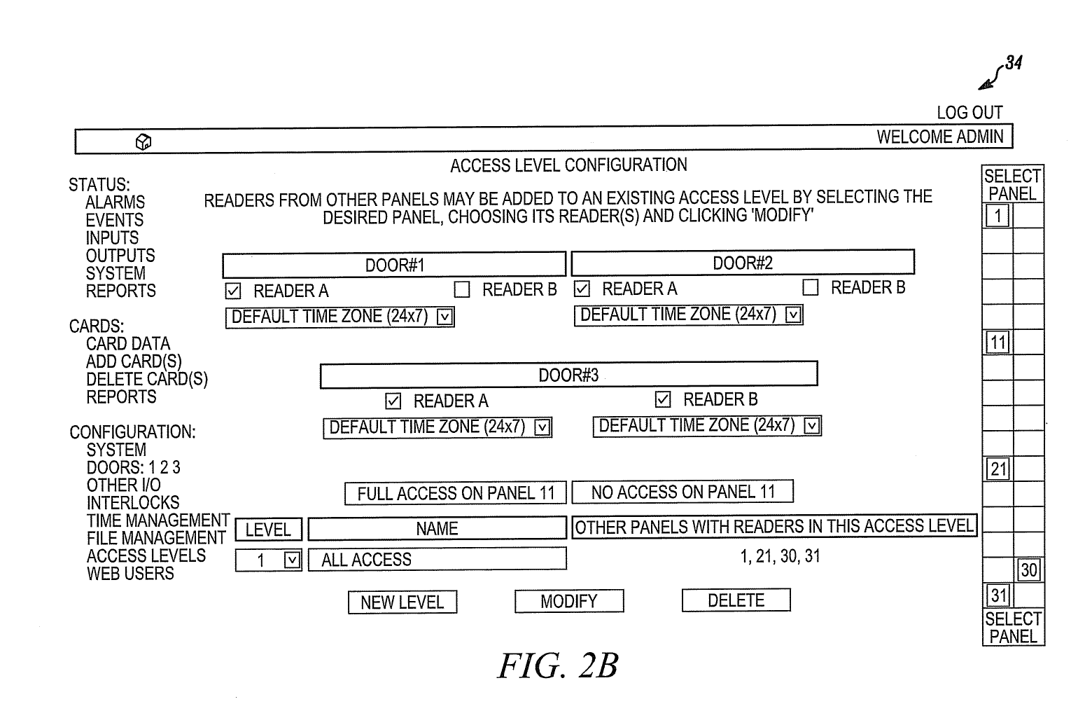

Configuration screens, such as 30, 34, best seen in FIGS. 2A, 2B can be presented on display 22b, on a real-time basis, based on data accumulated in the database 12e. Screens in accordance herewith provide an accurate representation to the user of the system 10 as it exists in real time.

FIG. 2A illustrates a configuration screen 30 for a panel, such as the panel 12, with a single on-line door with a primary Reader A which is active and a secondary Reader B which is disabled.

Screen 34 of FIG. 2B is a real-time configuration screen for a system with hardware for three doors. In accordance herewith, the screen is automatically rendered to enable configuration of all three doors.

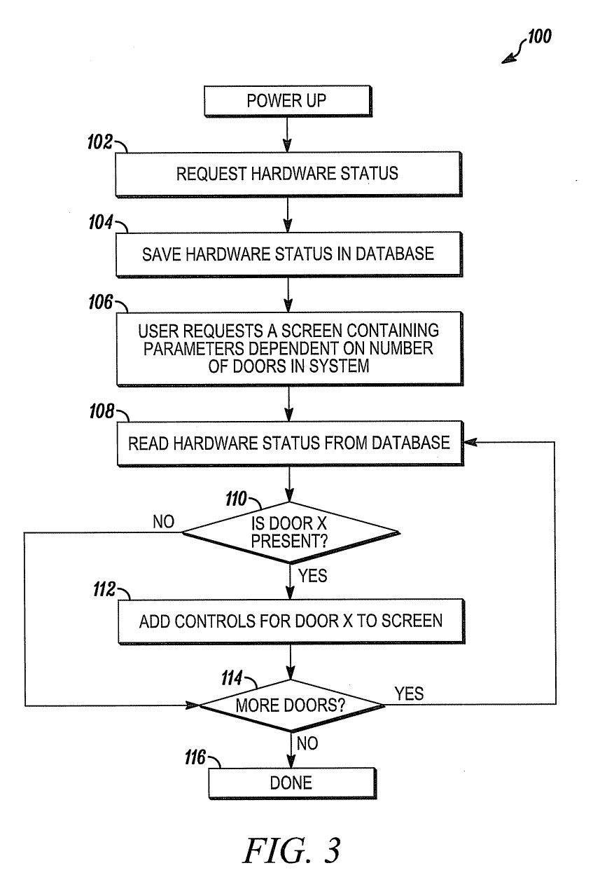

FIG. 3 is a flow diagram of aspects of a method 100. Once panel 12 has been energized, door hardware status can be requested, as at 102. Hardware status information can be stored in the data base 12e, as at 104. A user, via terminal 22, can request a display of a configuration screen, such as 30, 34 having door parameters based on the number of doors in the respective system, as at 106.

Door hardware status can be obtained from the database 12e, as at 108. Where the door is present, as at 110, the server 12d can add control information for that door to the screen such as 30, 34 as at 112. Data is sequentially obtained for the screen from all of the active doors, as at 114. The resultant screen, when the process has been concluded as at 116, is automatically presented on display 22b rendered appropriately to enable review and configuration by the user of all of the available doors.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. An access control system comprising:
door hardware communications circuitry to communicate with a plurality of door interfaces;
configuration establishing circuitry which receives information from the communications circuitry to determine which doors are active and their status; and
display circuitry, which receives information from the configuration establishing circuitry and which visually presents door configuration information, in real time.

2. A system as in claim 1 which includes storage circuitry, coupled to the configuration establishing circuitry, wherein configuration information can be stored for use by the display circuitry.

3. A system as in claim 1 wherein the configuration establishing circuitry and the display circuitry communicate via a computer network.

4. A system as in claim 1 where the configuration establishing circuitry includes a programmable processor and executable software that determines if a respective door is active and configurable via the display circuitry.

5. A system as in claim 1 where the display circuitry includes a multi-dimensional visual display upon which the display circuitry visually presents real time configuration information, reflective of status of a plurality of doors.

6. A system as in claim 3 where the configuration establishing circuitry includes a programmable processor and executable software that determines if a respective door is active and configurable via the display circuitry and where the display circuitry includes a multi-dimensional visual display upon which the display circuitry visually presents real time configuration information, reflective of status of a plurality of doors.

7. A system as in claim 3 which includes circuitry to store hardware status information as to various available doors.

8. A system as in claim 7 where the configuration establishing circuitry includes a storage unit for a door related database.

9. A system as in claim 8 where the configuration circuitry forwards door configuration information to a display for a user via a computer network.

10. A method comprising:
obtaining door hardware status information from a plurality of door interfaces in real-time;
storing the hardware status information in a database; and
responding to a request for configuration information by retrieving information from the data base; and forwarding it, as a real time representation to a requestor for review.

11. A method as in claim 10 which includes repetitively obtaining information from the database for each member of a plurality of active doors.

12. A method as in claim 10 which includes presenting information to the user as a configuration screen.

13. A method as in claim 12 which includes receiving configuration modification information in real time and updating information in the database.
